(19) United States
(12) Patent Application Publication
(10) Pub. No.: US 2013/0200766 A1
(43) Pub. Date: Aug. 8, 2013

(54) SUPPLY POD DISPENSER AND METHOD OF MAKING THE SAME

(71) Applicant: EMS MIND READER LLC, Newark, NJ (US)

(72) Inventor: Michael Betesh, Brooklyn, NY (US)

(73) Assignee: EMS MIND READER LLC, Newark, NJ (US)

(21) Appl. No.: 13/739,399

(22) Filed: Jan. 11, 2013

Related U.S. Application Data
(60) Provisional application No. 61/585,875, filed on Jan. 12, 2012.

(51) Int. Cl. A47B 46/00; E05B 65/46

(52) U.S. Cl. CPC A47B 46/00; E05B 65/463
USPC 312/295; 312/329

(57) ABSTRACT

An accessory dispenser that can include at least one compartment arrangement configured for holding at least one cartridge. The accessory dispenser can include a pivotable arrangement associated with the at least one compartment arrangement, and configured to pivot the at least one compartment arrangement about the pivotable arrangement. The accessory dispenser can also include at least one structure coupled to the pivot rod and associated with the at least one compartment, wherein, when the at least one compartment arrangement is coupled to the at least one structure, the at least one structure associates the at least one compartment with the pivot arrangement, and facilitates one or more compartments to be associated with the pivotable arrangement.

### CROSS-REFERENCE TO RELATED APPLICATION

This application relates to and claims priority from U.S. Provisional Patent Application No. 61/585,875 filed on Jan. 12, 2012, the disclosure of which is incorporated herein by reference in its entirety.

### FIELD OF THE DISCLOSURE

The present disclosure relates to a storage container for single-serve cartridges or supply pods for single-serve beverage dispensers.

BACKGROUND INFORMATION

Single serve coffee machines have gained market share in the office, home and home-office settings, as compared to more traditional pot-brewed (e.g., drip-brewed) coffee machines. Single serve coffee machines can come in any number of configurations. For example, some single-serve coffee machines can be drip-brewed (e.g., a smaller version of traditional “pot sized” machines), can have single-serve coffee pods (e.g., like the Keurig® “K-cup”), or various other single serve packet designs (e.g., liquid packets by Flavia®).

Accessory stations designed for traditional pot-sized drip-brewed arrangements may not adequately address the unique needs of a single serve beverage station. According to exemplary embodiments of the present disclosure, a single-serve supply pod or cartridge storage device can be provided which can obviate at least some of the deficiencies associated with the prior beverage dispensers.

### SUMMARY OF EXEMPLARY EMBODIMENTS

According to certain exemplary embodiments of the present disclosure, an exemplary supply cartridge storage device and dispenser for single-serve coffee machines is described.

In certain embodiments of the present disclosure, an exemplary accessory dispenser that can include at least one compartment arrangement configured for holding at least one cartridge. The accessory dispenser can include a pivotable arrangement associated with the at least one compartment arrangement, and configured to pivot the at least one compartment arrangement about the pivotable arrangement. The accessory dispenser can also include at least one structure coupled to the pivot rod and associated with the at least one compartment, wherein, when the at least one compartment arrangement is coupled to the at least one structure, the at least one structure associates the at least one compartment with the pivot arrangement, and facilitates one or more compartments to be associated with the pivotable arrangement.

The exemplary dispenser, in some configurations, can include a base coupled to the pivotable arrangement. The base, in some configurations, can have a predetermined weight that facilitates a prevention of the dispenser arrangement from being tipped over when the at least one compartment is in an open configuration.

In some configurations, the dispenser can include a holding structure configured to hold the compartment arrangement(s) in a closed configuration within the dispenser. The holding structure can also include a holding element that can be configured to mate with a receiving portion of the compartment arrangement(s) in some configurations.

The compartment(s) can include at least one divider disposed within the compartment(s). The compartment(s) can include groove slots configured to receive the divider(s).

In some configurations, the compartment(s) can comprise a plurality of compartments associated with the pivotable arrangement and with a plurality of structures, wherein the structures are disposed between each of the compartments.

The compartment(s) can be configured to maintain at least eight cartridges therein.

The compartment(s) can have a width that ranges from approximately 9 inches to approximately 13 inches that extends along a front portion of the dispenser, and can have a length generally perpendicular to the width ranging from approximately 4 inches to approximately 6 inches. In some configurations, the compartment(s) can have a width of approximately 10 inches that extends along a front portion of the dispenser. The compartment(s) can have a height that ranges from approximately 1 inch to approximately 3 inches. In one configuration, the compartment(s) can have a height of approximately 1.94 inches.

These and other objects, features and advantages of the exemplary embodiment of the present disclosure will become apparent upon reading the following detailed description of the exemplary embodiments of the present disclosure, when taken in conjunction with the appended claim(s).

### BRIEF DESCRIPTION OF THE DRAWINGS

Exemplary objects, features and advantages of the present disclosure will become apparent from the following detailed description taken in conjunction with the accompanying Figures showing illustrative embodiments of the present disclosure, in which:

FIG. 1A is a perspective view of an exemplary storage dispenser, according to an exemplary embodiment of the present disclosure;

FIG. 1B is a perspective view of an exemplary storage dispenser with the exemplary compartment in an open configuration, according to an exemplary embodiment of the present disclosure;

FIG. 2 is a partially unassembled perspective view of the exemplary dispenser without the exemplary storage compartments, according to another exemplary embodiment of the present disclosure;

FIG. 3 is a perspective view of the exemplary base of the exemplary dispenser of FIG. 2, without the exemplary compartments;

FIG. 4 is an illustration of two exemplary compartments with items therein, according to another exemplary embodiment of the present disclosure;

FIG. 5 is a front view of the exemplary dispenser;

FIG. 6 is a side view of the exemplary dispenser with one exemplary compartment in an open configuration;

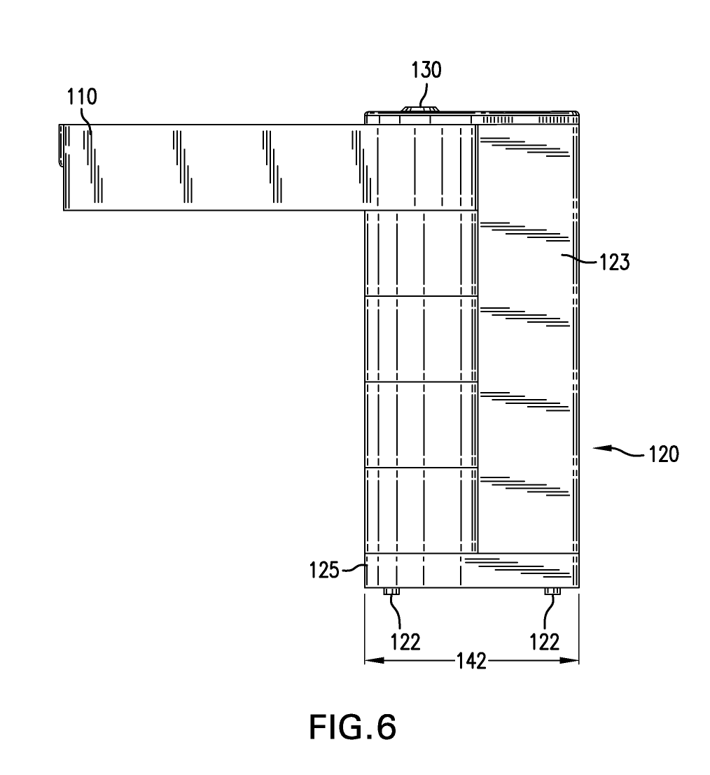

FIG. 7 is a top view of the exemplary dispenser;

FIG. 8 is another side view of an exemplary dispenser with one exemplary compartment in an open configuration, according to another exemplary embodiment of the present disclosure;

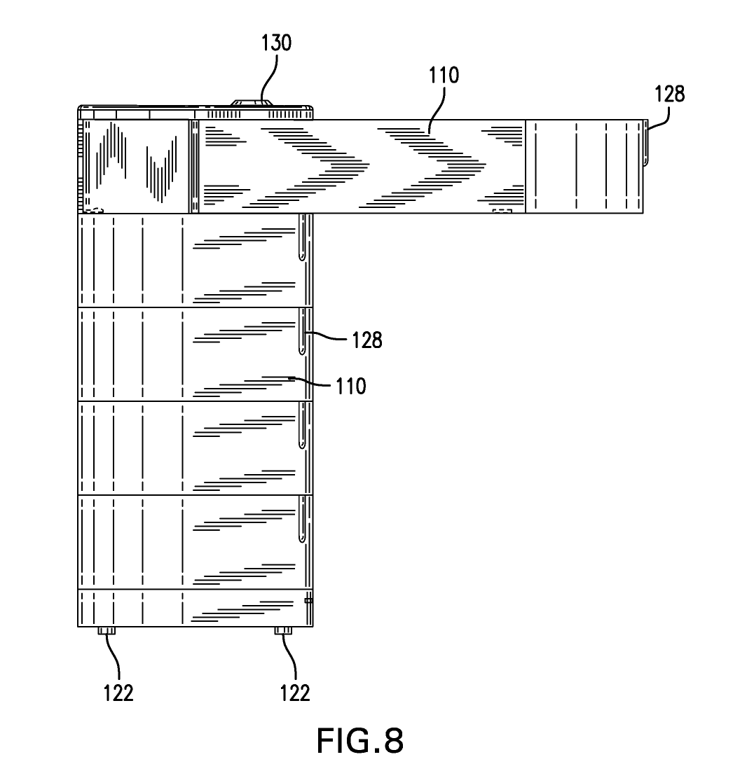

FIG. 9 is a side view of the exemplary compartment for the exemplary dispenser;

FIG. 10 is a front view of the exemplary compartment;

FIG. 11 is a top view of the exemplary compartment;

FIG. 12 is a bottom view of the exemplary compartment;

FIG. 13 is a side view of an exemplary base portion of an exemplary dispenser, according to another exemplary embodiment of the present disclosure;

FIG. 14 is a front view of the exemplary base unit; and

FIG. 15 is a side view of the exemplary base unit.

Throughout the drawings, the same reference numerals and characters, unless otherwise stated, are used to denote like features, elements, components, or portions of the illustrated embodiments. Moreover, while the present disclosure will now be described in detail with reference to the figures, it is done so in connection with the illustrative embodiments and is not limited by the particular embodiments illustrated in the figures, and/or described in the accompanying claims.

### DETAILED DESCRIPTION OF EXEMPLARY EMBODIMENTS

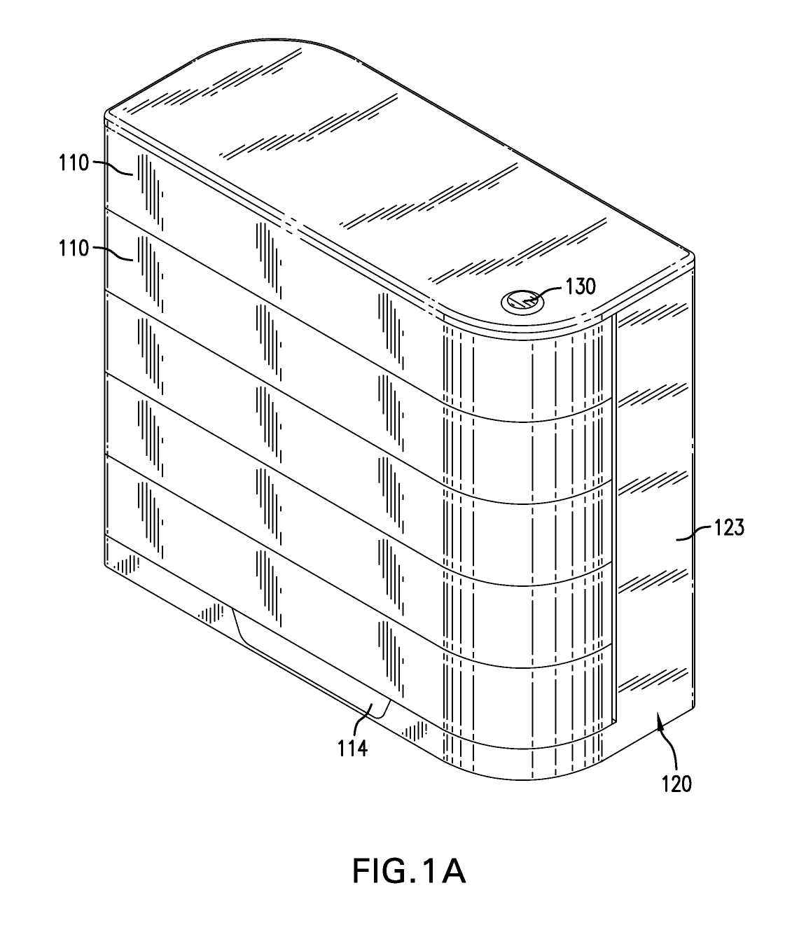

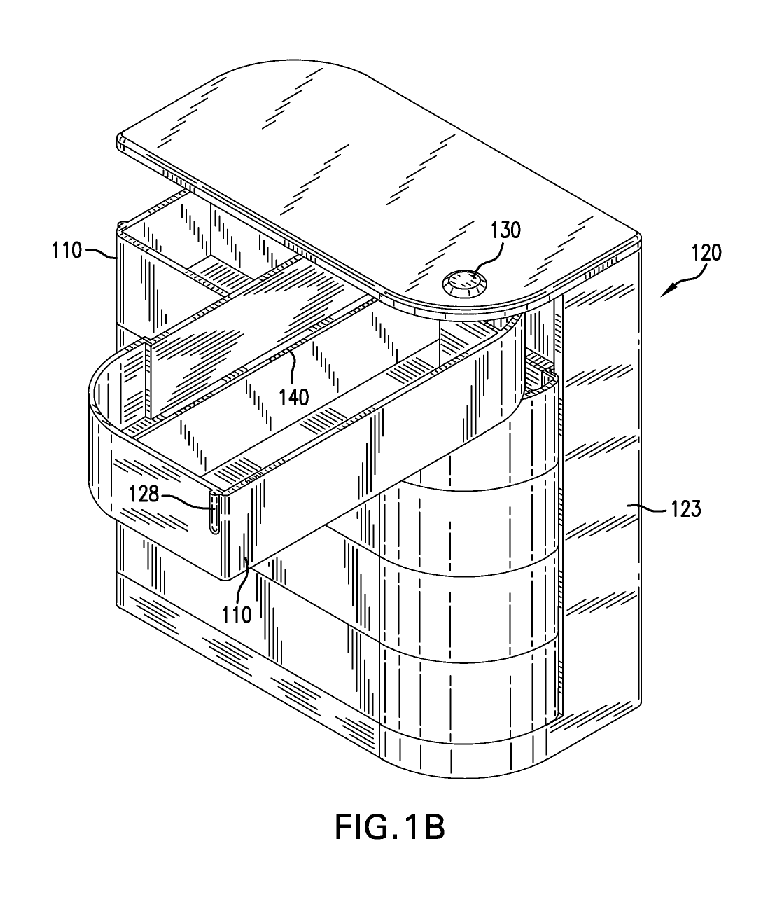

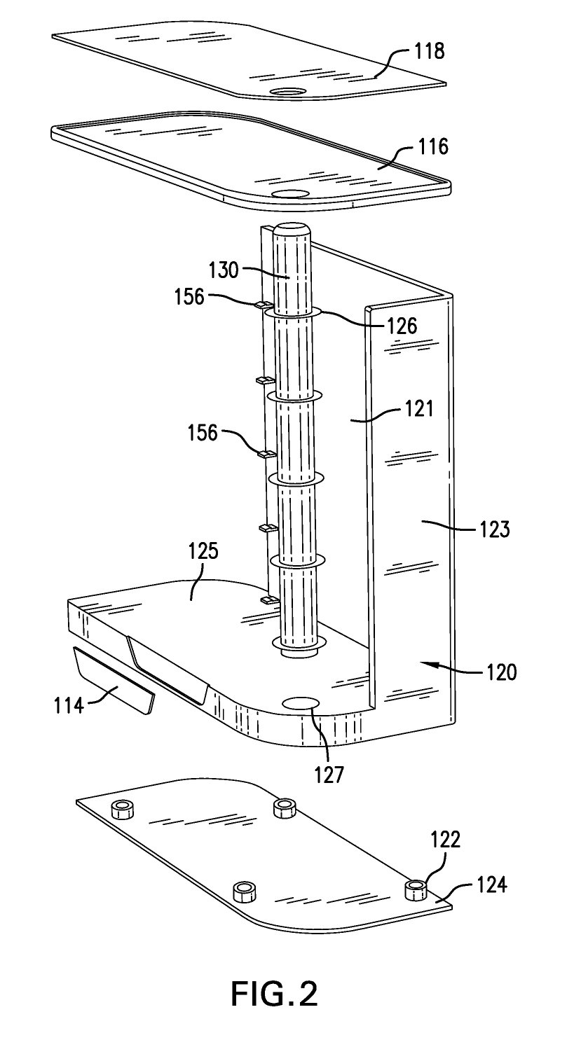

According to exemplary embodiments of the present disclosure, a supply-cartridge storage device can be provided for a single-serve beverage supply cartridges (hereinafter, the “dispenser”). FIGS. 1A, 1B, and 2 illustrate an exemplary dispenser with five storage compartments 110 that can swing out from base 120 around a pivot rod 130 (e.g., from the exemplary closed position in FIG. 1A to an exemplary open position in FIG. 1B). As illustrated in FIG. 2, the dispenser can include a logo plate 114 that is configured to receive a logo or label, e.g., the company logo or trademark. In one exemplary configuration, for example, the bottom portion 125 of the base 120 can include a plate receiving portion 115 configured to receive the logo plate 114. The plate receiving portion 115 can be generally the same shape and dimensions as the logo plate 114, or can have other suitable shapes and dimensions for receiving the logo plate 114. The logo plate 114 can be made of chrome, metal, plastic, and/or other similar material. In other configurations, the logo or label can be received directly on the base 120 without a logo plate 114.

The exemplary dispenser can include a top surface portion that includes a molded cap 116 and a molded piece 118 that is fitted in the molded cap 116. The exemplary base 120 can also be weighted such that it prevents the dispenser from tipping over when the compartments are open, e.g., swung open. The exemplary dispenser can also include a bottom plate 124 attached to the bottom side of the base 120 by bottom caps 124. The dispenser can include feet 122 that can grip to a surface and prevent the unit from sliding. In one exemplary configuration, the feet 122 can be included on the bottom cap 124. The bottom cap 124 can include 4 feet 122 in one exemplary configuration, but it is appreciated that other numbers of feet 122 can be used so long as it sufficiently grips a surface and prevents the unit from sliding. The base 120, molded cap 116, molded piece 118, and/or bottom plate 124 can be made of chrome, metal, plastic, and/or other similar materials. The feet 122 can be made of rubber, silicone, and/or other similar non-slip material.

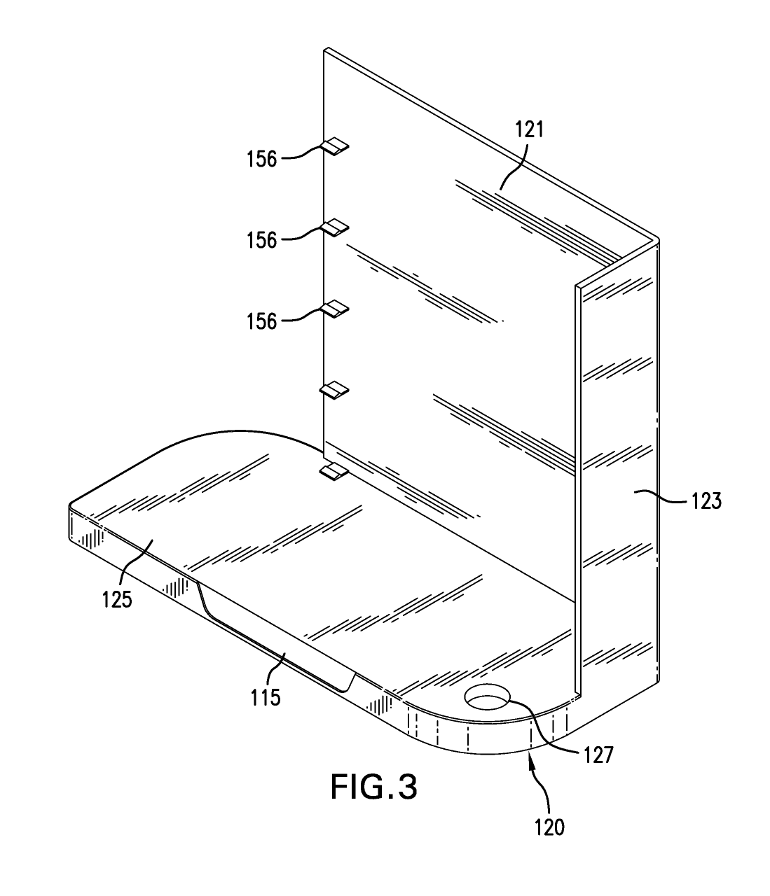

As illustrated in FIGS. 2 and 3, the exemplary base 120 can have a back wall portion 121, a side wall portion 123, and a bottom portion 125. The exemplary pivot rod 130 can be coupled with the exemplary base 120 at a base slot 127 disposed on the bottom portion 125. In one exemplary configuration, the base slot 127 can be a recessed portion of the bottom portion 125.

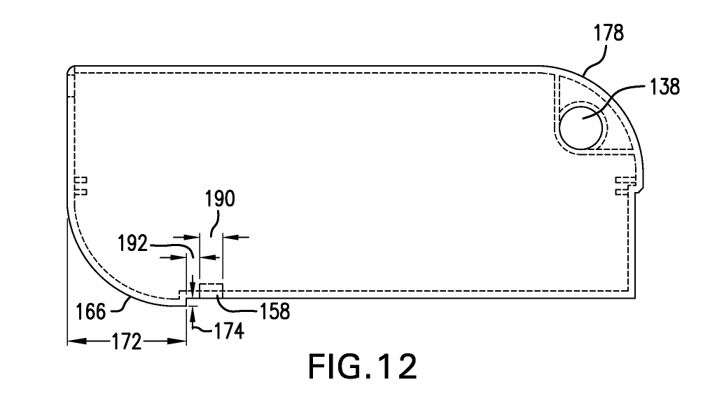

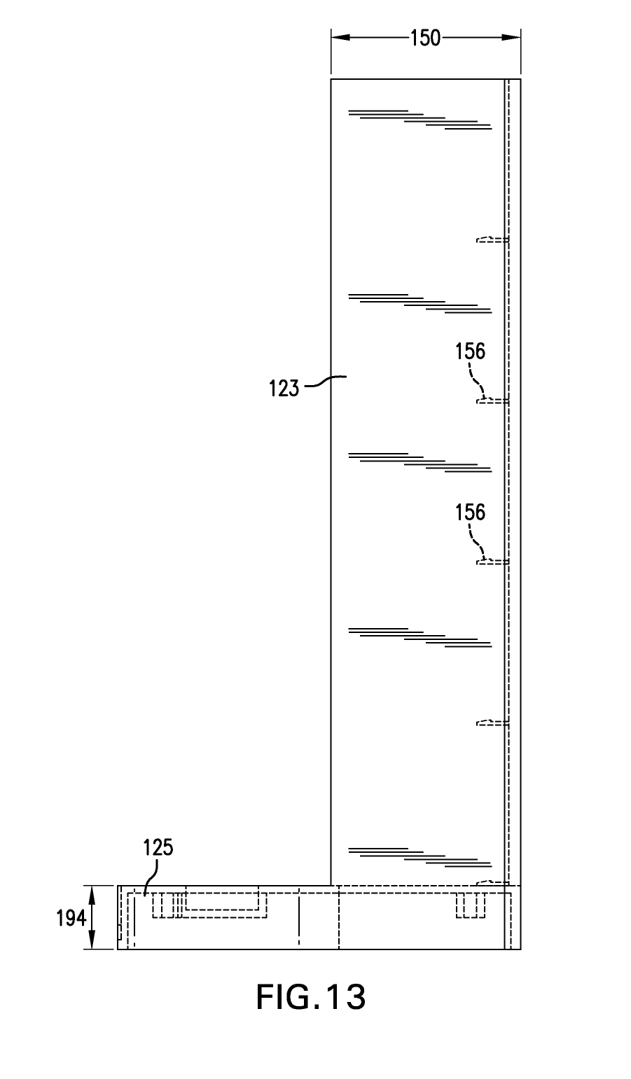

The exemplary carousel can further include a holding mechanism for holding, securing, or locking the exemplary compartments 110 in place when in the closed configuration. FIG. 3 illustrates one exemplary holding mechanism. The exemplary back wall 121 in one exemplary configuration can include holding elements 156 that can extend from the back wall 121 and can be configured to mate with a receiving portion 158 on the bottom of the exemplary compartment 110 (as shown in FIG. 12). The holding elements 156 can include a notch portion, hook, and/or a similar type mechanism that mates with a receiving portion 158 on the bottom of the exemplary compartment 110 to secure the compartment 110 in a closed configuration. In one exemplary configuration, such as when the dispenser has multiple exemplary compartments 110, the exemplary compartment 110 can also include a recessed portion (not shown) on the top side of the compartment 110 configured and dimensioned to receive the exemplary holding notch 156 securing the above exemplary compartment 110 such that the exemplary holding notch 156 does not interfere with the closure of the compartments 110 (e.g., the exemplary holding notch 156 mates with the exemplary receiving portion 158 of an exemplary compartment 110 without interfering with the closing of a second exemplary compartment 110 directly below). In one exemplary configuration, for example as shown in FIG. 13, the side wall portion 123 can have a width 150 of approximately 2.350 inches. Other dimensions are also possible.

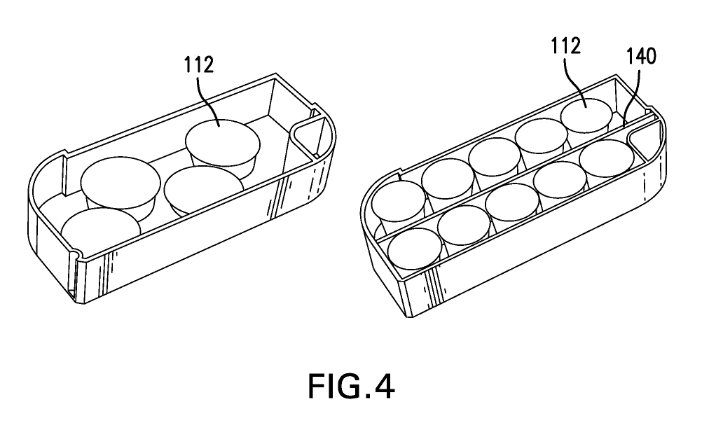

As illustrated in FIG. 4, each exemplary compartment 110 can hold multiple cartridges 112. Each exemplary compartment can be configured to fit any number of individual cartridges 112. For example, in one exemplary configuration, the compartment 110 can hold up to 8 cartridges 112. In other exemplary configurations, the compartment 110 can hold up to 10 cartridges 112. In yet other exemplary configurations, the compartment 110 can be configured to hold up to or less than 8, or more than 8 cartridges 112.

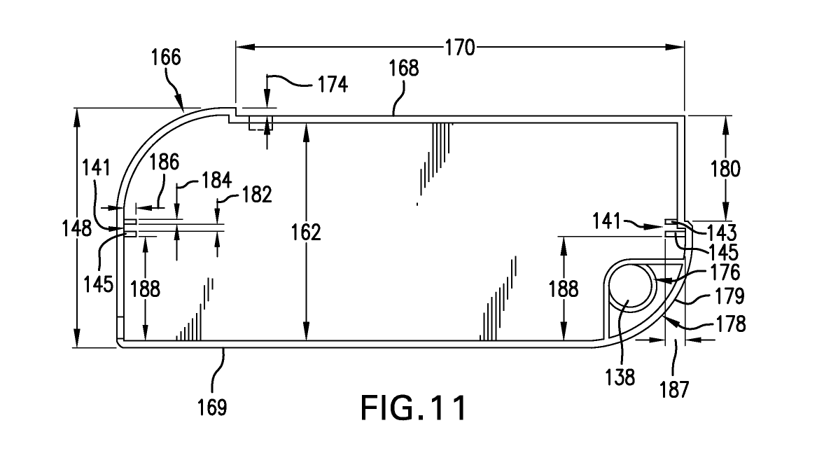

The exemplary compartment 110 can also include exemplary dividers 140. The exemplary dividers 140 can be removable (e.g., removable inserts) so that the compartments can be configured and reconfigured for differently shaped/sized supply cartridges 112, e.g., as shown in FIG. 4. The dividers 140 can be insertable into grooved slots 141 (for example, as seen in FIG. 11), or can be configured in any other suitable manner of providing a removable arrangement. The grooved slots 141 can be defined by two walls 143, 145 (as shown in FIG. 11). In other exemplary embodiments, dividers 140 can be permanently affixed within the compartment.

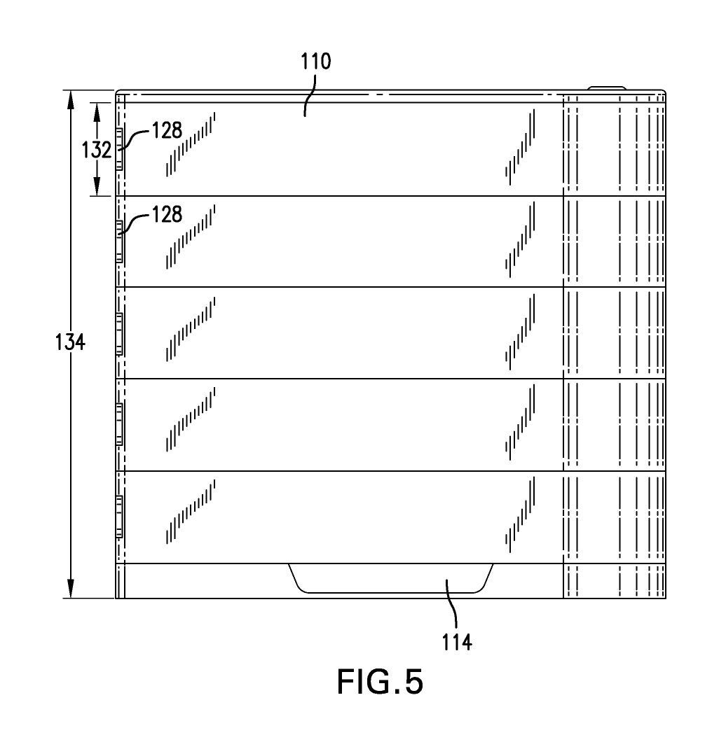

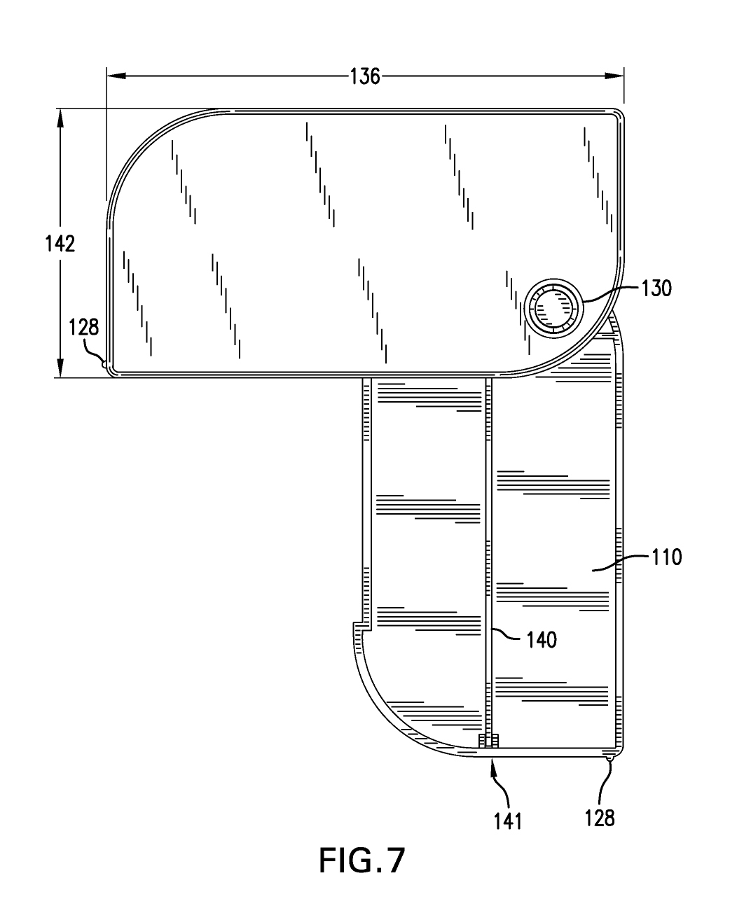

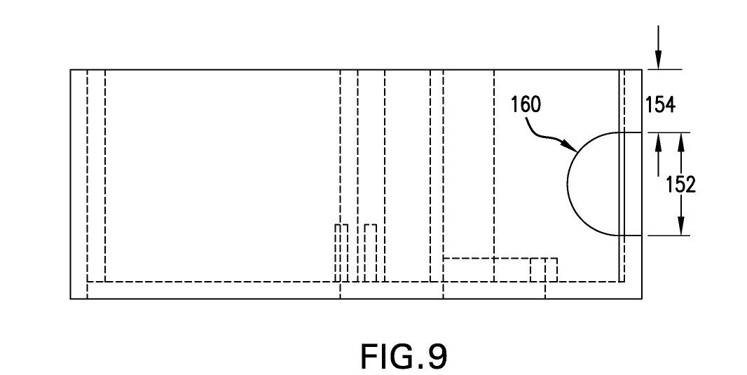

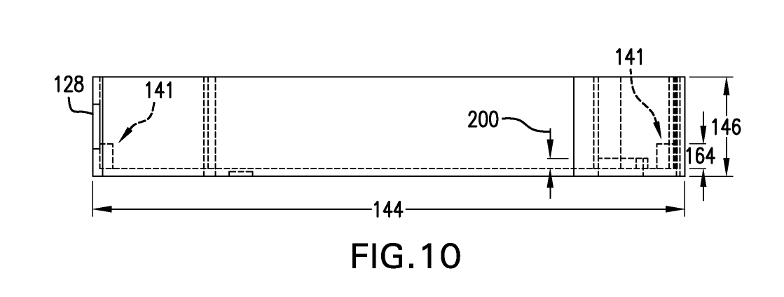

Each exemplary compartment 110 can be made of an opaque material, and/or can have a transparent front that can facilitate a user to view what is inside, or the whole compartment 110 can be made of a transparent material. The exemplary compartment 110 can be made of acrylic, plastic, metal, and/or other similar material. Further, each exemplary storage dispenser can include any number of compartments 110, such as the five illustrated in the exemplary figures. The exemplary compartments 110 can be associated with the exemplary pivot rod 130 such that the exemplary compartments 110 swing open with respect to the pivot rod 130 (as illustrated in FIG. 1B). For example, the exemplary compartment 110 can have a receiving slot 138 (as shown in FIGS. 7 and 9), configured to receive the pivot rod 130 such that the exemplary compartment 110 can swing open about the pivot rod 130 and reveal the contents stored in the compartment 110. The exemplary pivot rod 130 can include washers 126 or a similar suitable mechanism(s) that can separate multiple compartments 110. The washers 126 can also facilitate an individual compartment 110 to open without interfering with the other surrounding compartments 110. Each compartment 110 can include an opening feature 128, such as finger grooves (as shown in FIG. 5), a raised notch (as shown in FIG. 1B), or other exemplary features to facilitate a user opening the exemplary compartment (as shown in FIG. 5). For example, to open the compartment 110, the user can place his/her finger on the edge of the compartment 110, such as on a finger groove 128, in one exemplary configuration, and can move the exemplary compartment 110 from a closed position to an open position using the opening feature 128. The finger groove 128 can have a width 152 of 0.900 inches, and in certain exemplary configurations, the finger groove 128 can be spaced at a distance 154 of approximately 0.550 inches from the top of the exemplary compartment 110 (as shown in FIG. 10). The finger groove 128 can, in one exemplary configuration, have a generally half circle or crescent moon shape with a radius 160 of approximately 0.450 inches. According to other exemplary configurations, the finger groove 128 can have other shapes and dimensions. In yet other exemplary configurations, the exemplary compartment 110 can include handles, knobs, or other similar features to facilitate opening the compartment 110.

Various aspects of the present exemplary embodiments can have any sizing or set of dimensions, and the exemplary Figures illustrate at least one set of exemplary dimensions, while other exemplary dimensions are also possible. For example, the height 134 of the exemplary dispenser can be approximately 10.00 inches to approximately 11.100 inches. For example, in one exemplary configuration, the exemplary height 134 can be approximately 10.820 inches, in other exemplary configurations, the height 134 can be approximately 11.100 inches, and in yet another exemplary configuration, the height 134 can be approximately 11.57 inches. As shown in FIG. 7, the exemplary dispenser can have a width 136 that can range from, e.g., approximately 9 inches to approximately 13.00 inches. For example, in one exemplary configuration, the exemplary dispenser can have a width 136 of approximately 10 inches, in another exemplary embodiment the width 136 can be approximately 10.2 inches, and in yet another exemplary embodiment the width 136 can be approximately 12.00 inches. The exemplary dispenser can have a depth 142 of approximately 5.000 inches.

FIGS. 10 to 13 show additional exemplary dimensions and measures that can be used according to further exemplary embodiments of the present disclosure. For example, one exemplary configuration the exemplary compartment 110 can have a width 144 that ranges from, e.g., approximately 9.00 inches to approximately 12.00 inches (as shown in FIG. 10). For example, in one exemplary configuration, the width 144 can be, e.g., approximately 9.5 inches, in another exemplary configuration, the width 144 can be approximately 10 inches, and in yet another exemplary configuration, the width 144 can be approximately 12.00 inches. The exemplary compartment 110 can have a height 146 of that ranges from, e.g., approximately 1.00 inch to approximately 3.00 inches (as shown in FIG. 10). According to still another exemplary configuration, the height 146 can be approximately 1.875 inches, in other exemplary configurations, the height 146 can be approximately 1.940 inches, and in yet another exemplary configuration, the height 146 can be approximately 2.00 inches.

FIG. 11 illustrates a top view of the exemplary compartment with an exemplary set of dimensions according to exemplary embodiments of the present disclosure. For example, the exemplary compartment 110 can have a depth 148 (as shown in FIG. 11) that ranges from approximately 3.00 inches to 6.00 inches. In one exemplary configuration, the depth 148 can be approximately 5.00 inches, in other configurations, the depth 148 can be approximately 4.72 inches, and in yet another configuration, the depth 148 can be approximately 4.500 inches. The exemplary compartment can have an inner length 162 that ranges from, e.g., approximately 4.00 inches to approximately 6.00 inches. For example, in one exemplary configuration, the length 162 can be approximately 4.5 inches.

According to one exemplary configuration of the exemplary compartment 110, for example as shown in FIG. 11, the back side of the exemplary compartment 110 can include a curved corner portion 166 that extends beyond the back wall 168 of the exemplary compartment 110. In one exemplary embodiment, the curved corner portion 166 can extend from the back wall 168 such that the exemplary compartment 110 does not interfere with the holding mechanism. The curved corner portion 166 can extend from the back wall 168 at a distance 174 of, e.g., approximately 0.160 inches, The back wall 168 can have a length 170 that ranges from, e.g., approximately 6 inches to approximately 12 inches. For example, in one configuration, the length 170 can be approximately 7.25 inches. The curved portion 166 can have a distance 172 of, e.g., approximately 2.490 inches (as seen in FIG. 12). The curved portion 166 can extend from the back wall 168 at a distance 174 of, e.g., approximately 0.160 inches.

FIG. 11 further illustrates an example of the receiving slot 138. The exemplary receiving slot 138 can have radius 176 of, e.g., approximately 0.450 inches. The exemplary compartment 110 can include a curved edge 179 disposed near the receiving slot 138. The curved edge 179 can have a radius 178 of, e.g., approximately 2.250 inches. The curved edge 179 can extend from the side wall and can be positioned at distance 180 of, e.g., approximately 2.200 inches.

In addition, as discussed above, the exemplary grooved slots 141 (shown in phantom in FIG. 10) can be defined by walls 143,145, and in one exemplary configuration, the walls 143, 145 can have a height 164 of, e.g., approximately 0.500 inches. The distance 182 between the two walls 143,145 can be, e.g., approximately 0.150. The exemplary walls 143, 145 can have a thickness 184 of approximately 0.100 inches. In one exemplary configuration, the exemplary walls 143,145 can have a length 186 that ranges from approximately 0.250 inches to approximately 0.410 inches. In one exemplary configuration, the walls 143,145 can have equal lengths 186 (not shown). In other exemplary configurations, such as the exemplary configuration shown in FIG. 11, the walls 143,145 can have varying lengths. For example, one wall can have a length 186 of, e.g., approximately 0.250 while the opposite wall can have a length 187 of, e.g., approximately 0.410 inches. The grooved slots 141 can be positioned at a distance 188 of approximately 2.715 from the front wall 169.

FIG. 12 illustrates a bottom view of one exemplary configuration of an exemplary compartment 110 and a set of exemplary dimensions. For example, the receiving portion 158 can have a width 190 that ranges from approximately 0.463 inches to 1.77 inches. In one exemplary configuration, the width 190 can be approximately 0.463 inches. The receiving portion 158 can be positioned at a distance 192 of, e.g., approximately 0.283 from the curved corner portion 166.

FIG. 13 illustrates a side view of the exemplary base 120 with a set of exemplary dimensions according to an exemplary embodiment of the present disclosure. For example, the bottom portion 125 of the exemplary base 120 can have a height 194 of approximately 0.80 inches.

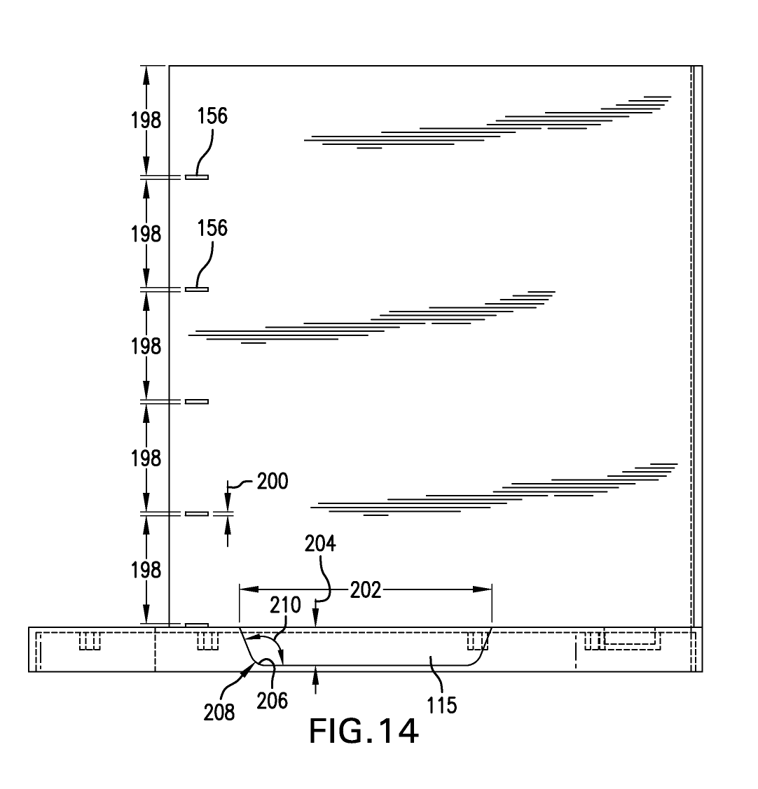

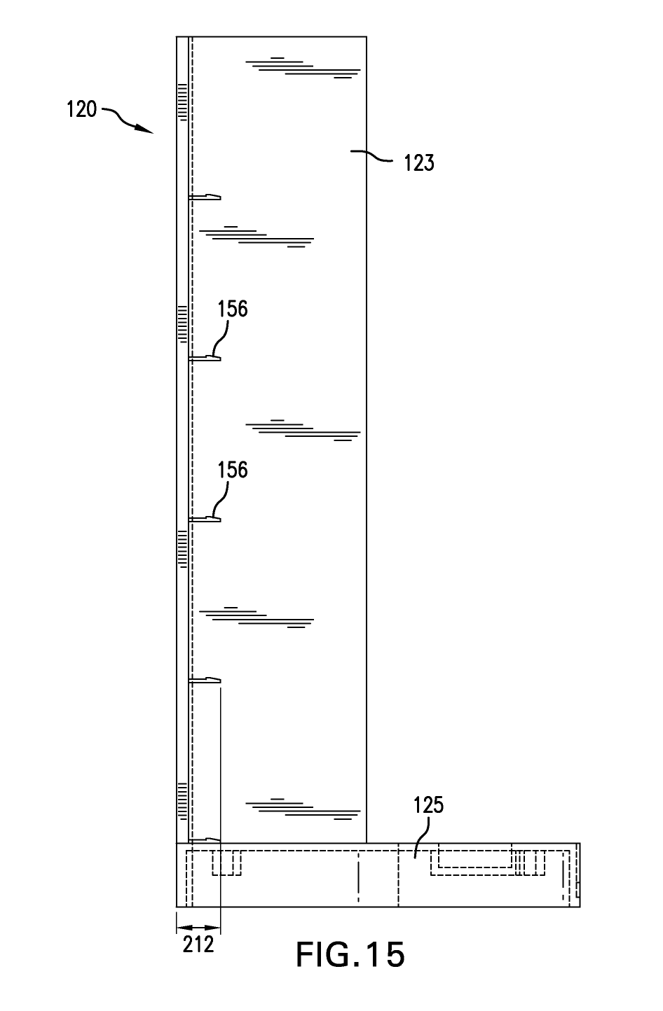

FIG. 14 illustrates a front view of the exemplary base 120 with exemplary holding elements 156 and a set of exemplary dimensions according to an exemplary embodiment of the present disclosure. The exemplary holding elements 156 can be spaced from each other at a distance 198 of approximately 1.940 inches. In one exemplary configuration, all the holding elements 156 can be spaced from each other at equal distances (as shown in FIG. 14), although it should be appreciated that in other exemplary configurations, the holding elements 156 can be spaced from each other at different distances depending on the dimensions of each exemplary compartment 110. Each exemplary holding notch 156 can have a thickness 200 of, e.g., approximately 0.060 inches in one exemplary configuration. Further, the length 212 of the exemplary holding notch 156 can be, e.g., approximately 0.350 (shown in FIG. 15).

FIG. 14 further illustrates a side view of an exemplary embodiment of the plate receiving portion 115 with an exemplary set of dimensions according to an exemplary embodiment of the present disclosure. For example, the plate receiving portion 115 can have a generally trapezoidal shape. The top side of the plate receiving portion 115 can have a width 202 of, e.g., approximately 4.400 inches. The plate receiving portion 115 can have a height 204 of approximately 0.675 inches. The exemplary plate receiving portion 115 can also include curved edges, for example, curved edge 206. The curved edge 206 in one exemplary embodiment can have a radius 208 of 0.300 inches and an angle 210 of 11.200 degrees. Exemplary compartments 110 can be used to store other items as well, such as sugar packets, tea bags, stirrers, spoons, etc. Further, exemplary dispensers can be used in other contexts (e.g., other than single-serve beverage accessories, such as holding paper clips, staples, post-it notes, etc.) Exemplary containers can be used as stand-alone accessory storage containers, or in conjunction with other exemplary storage containers.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. In addition, all publications and references referred to above can be incorporated herein by reference in their entireties. In addition, certain terms used in the present disclosure, including the specification, drawings and text thereof, can be used synonymously in certain instances, including, but not limited to, e.g., data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it can be explicitly being incorporated herein in its entirety, All publications referenced above can be incorporated herein by reference in their entireties.

What is claimed:

1. A dispenser arrangement for storing cartridges, comprising:
at least one compartment arrangement configured for holding at least one cartridge;
a pivotable arrangement associated with the at least one compartment arrangement, and configured to pivot the at least one compartment arrangement about the pivotable arrangement; and
at least one structure coupled to the pivot rod and associated with the at least one compartment, wherein, when the at least one compartment arrangement is coupled to the at least one structure, the at least one structure associates the at least one compartment with the pivot arrangement, and facilitates one or more compartments to be associated with the pivotable arrangement.

2. The dispenser of claim 1, further comprising a base coupled to the pivotable arrangement.

3. The dispenser of claim 2, wherein the base has a predetermined weight that facilitates a prevention of the dispenser arrangement from being tipped over when the at least one compartment is in an open configuration.

4. The dispenser of claim 1, further comprising a holding structure configured to hold the at least one compartment arrangement in a closed configuration within the dispenser.

5. The dispenser of claim 4, wherein the holding structure further comprises a holding element that is configured to mate with a receiving portion of the at least one compartment arrangement.

6. The dispenser of claim 1, wherein the at least one compartment includes at least one divider disposed within the at least one compartment.

7. The dispenser of claim 6, wherein the at least one compartment includes groove slots configured to receive the at least one divider.

8. The dispenser of claim 1, wherein the at least one compartment comprises a plurality of compartments associated with the pivotable arrangement and with a plurality of structures, wherein the structures are disposed between each of the compartments.

9. The dispenser of claim 1, wherein the at least one compartment is configured to maintain at least eight cartridges therein.

10. The dispenser of claim 1, wherein the at least one compartment has a width that ranges from approximately 9 inches to approximately 13 inches that extends along a front portion of the dispenser, and length generally perpendicular to the width ranging from approximately 4 inches to approximately 6 inches.

11. The dispenser of claim 1, wherein the at least one compartment has a width of approximately 10 inches that extends along a front portion of the dispenser.

12. The dispenser of claim 1, wherein the at least one compartment has a height that ranges from approximately 1 inch to approximately 3 inches.

13. The dispenser of claim 1, wherein the at least one compartment has a height of approximately 1.94 inches.
